(19) United States
(12) Patent Application Publication
(10) Pub. No.: US 2023/0256434 A1
(43) Pub. Date: Aug. 17, 2023

(54) CARTRIDGE AND LIQUID HANDLING DEVICE

(71) Applicant: Enplas Corporation, Saitama (JP)

(72) Inventor: Koichi ONO, Saitama (JP)

(73) Assignee: Enplas Corporation, Saitama (JP)

(21) Appl. No.: 18/107,550

(22) Filed: Feb. 9, 2023

(30) Foreign Application Priority Data
Feb. 17, 2022 (JP) 2022-023066

(51) Int. Cl. B01L 3/00

(52) U.S. Cl. CPC B01L 3/502715; B01L 3/50273; B01L 3/502738; B01L 2200/027; B01L 2400/0655

(57) ABSTRACT

A cartridge includes a main body, a reservoir disposed inside the main body and configured to store a liquid, and a tube configured such that the liquid taken in from one end of the tube communicating with the reservoir flows out from another end of the tube, in which the tube includes a pressed portion that controls a flow of the liquid by causing the tube to be deformed when the tube is pressed or released from being pressed, and the pressed portion is located outside the main body.

### CROSS REFERENCE TO RELATED APPLICATIONS

This application claims the benefit of priority of Japanese Patent Application No. 2022-023066, filed on Feb. 17, 2022, the contents of which are incorporated by reference as if fully set forth herein in their entirety.

### TECHNICAL FIELD

The present invention relates to a cartridge used in combination with a channel chip having a channel through which a liquid flows, and a liquid handling device including the cartridge.

### BACKGROUND ART

In recent years, channel chips and the like have been used for analysis of cells, proteins, nucleic acids, and the like. Advantageously, the channel chip requires only a small amount of reagents and samples for the analysis, and are expected to be used in various applications such as clinical tests, food tests, and environmental tests (see, e.g., Patent Literature (hereinafter, referred to as “PTL” 1)).

PTL 1 describes a device including a microchannel chip including a channel and used for conducting analysis, and a cartridge in which a liquid such as a reagent or a buffer solution is stored inside a chamber and which is configured to supply the liquid to the microchannel chip. The cartridge described in PTL 1 includes the chamber for storing a liquid, a plurality of nozzles communicating with the chamber and corresponding to a plurality of injection ports of the microchannel chip, and caps for sealing the nozzles.

In the device of PTL 1, the caps are detached from the nozzles, and the cartridge is connected to the microchannel chip. Then, a reagent, a buffer solution, or the like is sent from the cartridge to the microchannel chip as necessary to conduct analysis. In PTL 1, one cartridge is used for one microchannel chip in a disposable manner.

### CITATION LIST

### Patent Literature

### PTL 1

Japanese Unexamined Patent Application Publication (Translation of PCT Application) No. 2010-502217

### SUMMARY OF INVENTION

### Technical Problem

Here, from the viewpoint of reducing the disposal of the liquid in the cartridge, it is conceivable to repeatedly use the cartridge described in PTL 1 for a plurality of microchannel chips. However, the cartridge described in PTL 1 is not assumed to be detached after being connected to the microchannel chip once. Therefore, in the case where the cartridge described in PTL 1 is repeatedly used for a plurality of microchannel chips, liquid leaks from the nozzles until the nozzles are connected to another microchannel chip after the liquid is supplied to the microchannel chip.

An object of the present invention is to provide a cartridge making it possible to supply a liquid to a plurality of channel chips. Another object of the present invention is to provide a liquid handling device including the cartridge.

### Solution to Problem

A cartridge of the present invention is a cartridge that is used in combination with a channel chip including a channel through which a liquid flows, the cartridge being configured to store the liquid, the cartridge including: a main body; a reservoir disposed inside the main body and configured to store the liquid; and a tube configured such that the liquid taken in from one end of the tube communicating with the reservoir flows out from another end of the tube, in which the tube includes a pressed portion that controls a flow of the liquid by causing the tube to be deformed when the tube is pressed or released from being pressed, and the pressed portion is located outside the main body.

A liquid handling device of the present invention includes: a cartridge of the present invention; a channel chip including an inlet for introducing a liquid of the reservoir and a channel through which the liquid introduced through the inlet flows; and an interface for connecting the cartridge and the channel chip to each other.

### Advantageous Effects of Invention

According to the present invention, it is possible to provide a cartridge and a liquid handling device making it possible to supply liquid to a plurality of channel chips.

### BRIEF DESCRIPTION OF DRAWINGS

FIGS. 1A and 1B are diagrams illustrating a configuration of a liquid handling device according to Embodiment 1;

FIG. 2 is a sectional view of the liquid handling device;

FIG. 3 is a cross-sectional view illustrating a configuration of a channel chip and an interface;

FIG. 4 is a diagram illustrating a configuration of a liquid handling device according to a variation of Embodiment 1;

FIGS. 5A to 5C are sectional views illustrating other forms of the cartridge; and

FIGS. 6A and 6B are sectional views illustrating other forms of the cartridge.

### DESCRIPTION OF EMBODIMENTS

Hereinafter, a liquid handling device according to the present embodiment will be described with reference to the accompanying drawings.

### Embodiment 1

### (Configuration of Liquid Handling Device)

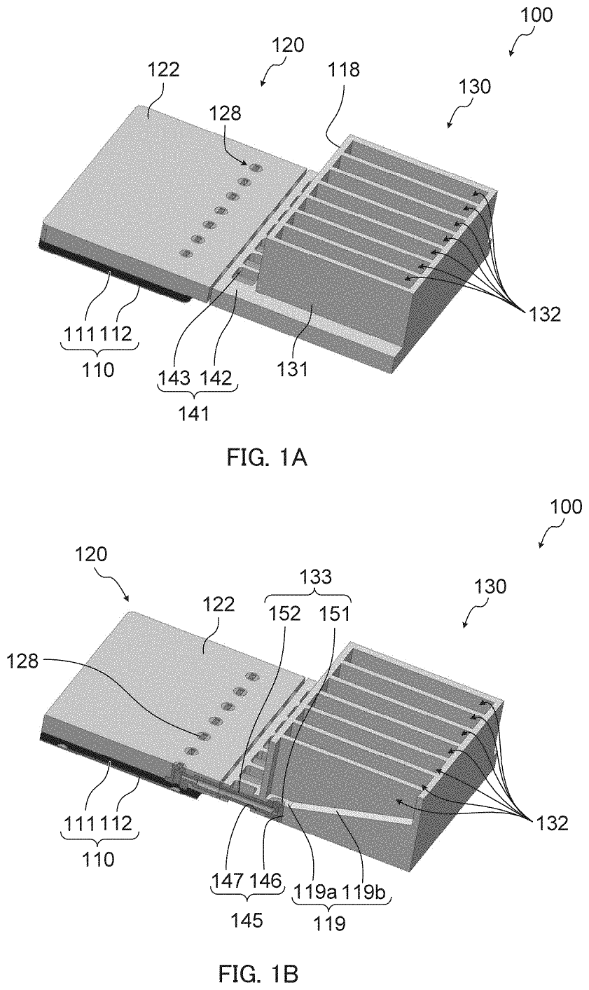

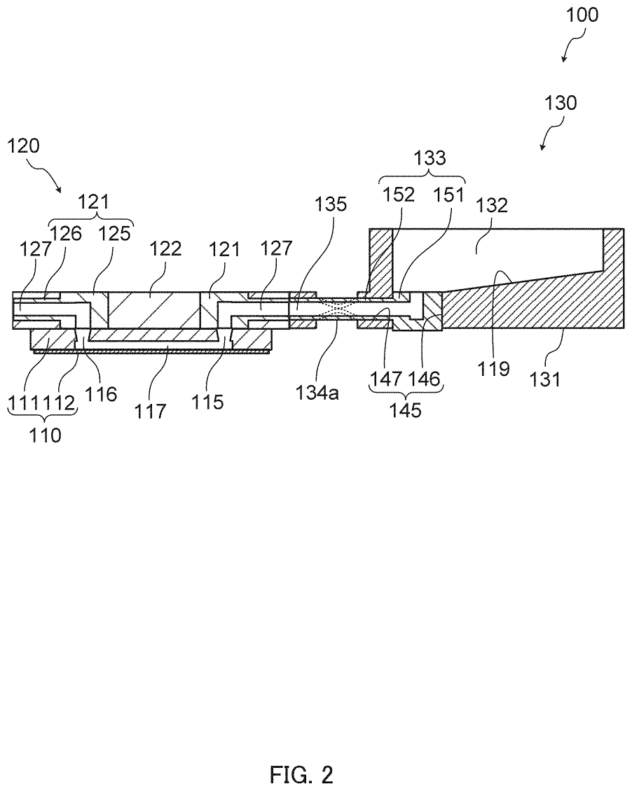

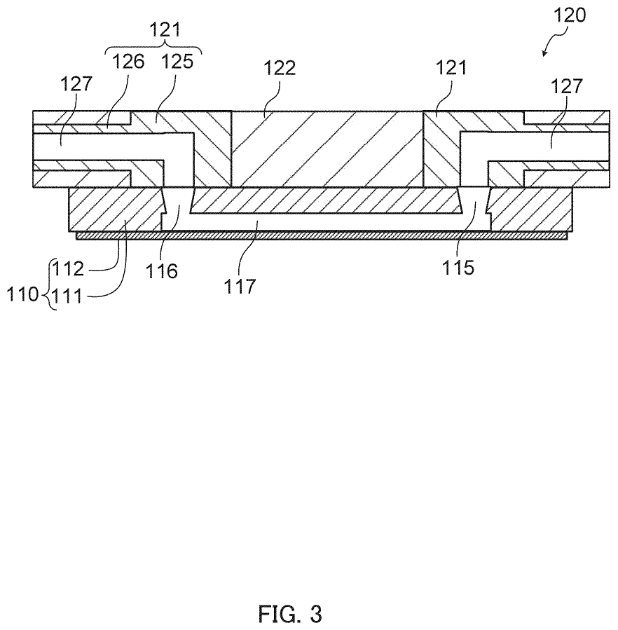

FIGS. 1A, 1B, and 2 are diagrams illustrating a configuration of liquid handling device 100. FIG. 1A is a perspective view of liquid handling device 100, and FIG. 1B is a sectional perspective view of liquid handling device 100. In FIG. 1B, hatching for indicating the section is omitted. FIG. 3 is a sectional view illustrating a configuration of channel chip 110 and interface 120.

As illustrated in FIGS. 1A, 1B, 2, and 3, liquid handling device 100 includes channel chip 110, interface 120, and cartridge 130.

Channel chip 110 includes board 111 and film 112. In board 111, grooves for forming channel 117 and through holes for forming inlet 115 or outlet 116 are formed. Film 112 is bonded to one surface of board 111 so as to close opening portions of the grooves and the through holes formed in board 111. Some regions of film 112 may function as diaphragms of a valve or a pump. Each of the grooves in board 111 closed by film 112 serves as channel 117 through which a liquid such as a reagent, a liquid sample, or a cleaning liquid flows.

The thickness of board 111 is not particularly limited. For example, the thickness of board 111 is not less than 1 mm and not more than 10 mm. The material of board 111 is not particularly limited. For example, the material of board 111 may be appropriately selected from known resins and glass. Examples of the resins of the material of board 111 include polyethylene terephthalate, polycarbonate, polymethyl methacrylate, polyvinyl chloride, polypropylene, polyether, polyethylene, polystyrene, cycloolefin-based resins, silicone resins, and elastomers.

Film 112 closes the opening portions of the grooves or the through holes formed in board 111. For example, the thickness of film 112 is not less than 30 μm and not greater than 300 μm. The material of film 112 may be appropriately selected from known resins. Examples of the material of film 112 include polyethylene terephthalate, polycarbonate, polymethyl methacrylate, polyvinyl chloride, polypropylene, polyether, polyethylene, polystyrene, cycloolefin-based resins, silicone resins, and elastomers. Film 112 is bonded to board 111 by, for example, thermal welding, laser welding, or an adhesive.

In the present embodiment, channel chip 110 includes inlet 115 for introducing a liquid, outlet 116 for discharging the liquid, and channel 117 through which the liquid flows. The numbers of inlets 115, outlets 116, and channels 117 are not particularly limited, and are appropriately set according to the use of channel chip 110.

Inlet 115 is a bottomed recess for introducing a liquid such as a sample or a reagent stored inside cartridge 130. Inlet 115 is composed of a through hole formed in board 111 and film 112 that closes one opening portion of the through hole. The shape and size of inlet 115 are not particularly limited, and may be appropriately set. In the present embodiment, the shape of inlet 115 is an inverted truncated cone shape. The length of the opening portion of inlet 115 is, for example, about 2 mm.

Outlet 116 is a bottomed recess for discharging the liquid inside channel 117. Outlet 116 is composed of a through hole formed in board 111 and film 112 that closes one opening portion of the through hole. The shape and size of outlet 116 are not particularly limited, and may be appropriately set. In the present embodiment, the shape of outlet 116 is an inverted truncated cone shape. The length of the opening portion of outlet 116 is, for example, about 2 mm.

Channel 117 is configured to allow, to flow therethrough, the liquid introduced through inlet 115. Channel 117 has, for example, a substantially rectangular shape in which the lengths (width and depth) of one side are about several tens of μm. The cross-sectional area of channel 117 may or may not be constant in the flow direction of the liquid. Here, the cross-sectional area of the channel refers to the area of the cross section of the channel taken perpendicular to the flow direction of the liquid. In the present embodiment, the cross-sectional area of channel 117 is constant in the flow direction of the liquid.

Interface 120 connects channel chip 110 and cartridge 130 to each other. Interface 120 in the present embodiment is also connected to channel chip 110 and equipment located outside the figures. Interface 120 includes first member 121 and a plurality of second members 122. It is preferable that first member 121 and second members 122 be formed by double molding or insert molding. Interface 120 is disposed substantially parallel to the bottom surface and the top surface of channel chip 110.

First member 121 includes first channel member 125 and second channel member 126. First channel member 125 and second channel member 126 are connected to each other. In the present embodiment, first channel member 125 and second channel member 126 are integrated with each other. It is preferable that first member 121 have elasticity. Examples of the material of first member 121 include an elastomer and a resin. Thus, formation of a gap is suppressed between first channel member 125 and the opening portions in channel chip 110. Accordingly, a fluid (for example, a gas, a liquid, or the like) passing through the channel is prevented from leaking from between first member 121 and channel chip 110 to the outside.

The angle formed between the central axis of first channel member 125 and the central axis of second channel member 126 is not particularly limited. It is preferable that the angle formed between the central axis of first channel member 125 and the central axis of second channel member 126 be less than 180°. The angle formed between the central axis of first channel member 125 and the central axis of second channel member 126 may be an acute angle, an obtuse angle, or a right angle (90°). In the present embodiment, the angle formed between the central axis of first channel member 125 and the central axis of second channel member 126 is 90°. In the present embodiment, first channel member 125 is disposed along a direction substantially perpendicular to the bottom surface of channel chip 110, and second channel member 126 is disposed along a direction substantially parallel to the bottom surface of channel chip 110. Thus, first channel member 125 and second channel member 126 have an L-shape as a whole, and cartridge 130 connected to second channel member 126 can be disposed not above channel chip 110 but laterally to channel chip 110. First channel member 125 and second channel member 126 form L-shaped interface channel 127 as a whole. A plurality of sets of interface channels 127 may be provided. In this case, the angle formed between a channel formed by first channel member 125 and a channel formed by second channel member 126 may be less than 180°.

Each of second members 122 supports first member 121. The shape of second member 122 is not particularly limited as long as it can exert the above-described function. In the present embodiment, the shape of second member 122 is a plate shape. It is preferable that second member 122 be harder than first member 121. Examples of the material of second member 122 include an elastomer and a resin. Accordingly, second member 122 can appropriately support first member 121.

In addition, first channel member 125 may have needle insertion portions 128 (see FIGS. 1A and 1B). Each of needle insertion portions 128 is a portion into which a hollow needle is inserted from the outside to the inside of first channel member 125 or second channel member 126, and a liquid is introduced.

Cartridge 130 stores therein the liquid to be supplied to channel 117 in channel chip 110, and is used by being connected to channel chip 110 via interface 120. Cartridge 130 includes main body 131, reservoirs 132, and tubes 133.

Each of reservoirs 132 for storing a liquid is disposed inside main body 131. Main body 131 supports tubes 133 connected to reservoirs 132. The outer shape of main body 131 is not particularly limited. In the present embodiment, the outer shape of main body 131 is a substantially rectangular parallelepiped shape. Exposure section 141 for exposing a portion of each of tubes 133 is disposed in main body 131.

The material of main body 131 is not particularly limited as long as it can exert the above-described functions. Examples of the material of main body 131 include resin, glass, and metal. Examples of the resin include polyethylene terephthalate, polycarbonate, polymethyl methacrylate, polyvinyl chloride, polypropylene, polyether, polyethylene, polystyrene, cycloolefin-based resins, silicone resins, and elastomers, as examples of materials for main body 131.

Exposure section 141 exposes a portion of tube 133 to cause tube 133 to be pressed by pressing portion 134. Exposure section 141 includes protrusion 142 and exposure holes 143 disposed in protrusion 142. Tube 133 is disposed inside protrusion 142, and a portion of tube 133 is exposed to the outside at each of exposure holes 143. The position of protrusion 142 is not particularly limited. In the present embodiment, protrusion 142 protrudes laterally from side surface 118 of main body 131 at the lower portion. Exposure hole 143 may be a through hole that extends through protrusion 142 in the up-down direction, may be a recessed portion that opens in the upper surface of protrusion 142, or may be a recessed portion that opens in the lower surface of protrusion 142. In the present embodiment, exposure hole 143 is a through hole that extends through protrusion 142 in the up-down direction.

Each of reservoirs 132 is a recess for storing a liquid to be introduced into the inside of channel chip 110. Communication portion 145 opens in bottom surface 119 of reservoir 132. Bottom surface 119 may be a single surface or a plurality of surfaces. In the present embodiment, bottom surface 119 includes horizontal surface 119a and inclined surface 119b. The numbers of horizontal surfaces 119a and inclined surfaces 119b are not particularly limited. In the present embodiment, one horizontal surface 119a and one inclined surface 119b are provided. Bottom surface 119 may be either horizontal surface 119a or inclined surface 119b. The number of reservoirs 132 is not particularly limited. In the present embodiment, the number of reservoirs 132 is seven. The capacity of reservoir 132 is not particularly limited. For example, the capacity of reservoir 132 ranges from 0.01 to 500 mL.

Communication portion 145 functions as a part of a channel for guiding the liquid in reservoir 132 to channel chip 110. In the present embodiment, one end of communication portion 145 opens in bottom surface 119 of reservoir 132 at the lowest position from the viewpoint of facilitating the flow of liquid to tube 133. The opening portion of communication portion 145 in reservoir 132 functions as an outlet of the liquid in reservoir 132. Tube 133 is disposed in at least a portion of communication portion 145. In the present embodiment, an elastic tube is disposed from one end to the other end of communication portion 145.

In the present embodiment, communication portion 145 includes first communication portion 146 and second communication portion 147. The angle formed between the central axis of first communication portion 146 and the central axis of second communication portion 147 is not particularly limited. The angle formed between the central axis of first communication portion 146 and the central axis of second communication portion 147 may be an acute angle, an obtuse angle, or a right angle. In the present embodiment, the angle formed between the central axis of first communication portion 146 and the central axis of second communication portion 147 is a right angle. The arrangement direction of communication portion 145 is the same as the arrangement direction of tube 133. In the present embodiment, first communication portion 146 is disposed along the height direction of cartridge 130 (the depth direction of reservoir 132). One end of first communication portion 146 opens in the bottom surface of main body 131. The other end of the first communication hole may be opened in the bottom surface of main body 131, or does not have to be opened in the bottom surface of main body 131. That is, first communication portion 146 may be a recessed portion that opens in the bottom surface of reservoir 132, or may be a through hole that communicates between the bottom surface of reservoir 132 and the bottom surface of main body 131. In the present embodiment, first communication portion 146 is a through hole that communicates between the bottom surface of reservoir 132 and the bottom surface of main body 131.

In the present embodiment, second communication portion 147 is disposed along the horizontal direction. One end of second communication portion 147 opens in first communication portion 146, and the other end opens in the side surface of protrusion 142. Tube 133 is disposed on at least a portion of second communication portion 147 which overlaps exposure hole 143.

Tube 133 is disposed within at least a part of communication portion 145 so as to be exposed in exposure hole 143, and forms at least a part of the channel for flowing the liquid stored in reservoir 132 toward channel chip 110 (interface 120). That is, tube 133 is configured such that the liquid taken in from one end of tube 133 communicating with reservoir 132 flows out from the other end. Tube 133 only has to be disposed at a position corresponding to exposure section 141. In the present embodiment, tube 133 includes first tube 151 and second tube 152. In the present embodiment, first tube 151 and second tube 152 are integrally formed. The angle formed between the central axis of first tube 151 and the central axis of second tube 152 is not particularly limited. It is preferable that the angle formed between the central axis of first tube 151 and the central axis of second tube 152 be less than 180°. The angle formed between the central axis of first tube 151 and the central axis of second tube 152 may be an acute angle, an obtuse angle, or a right angle. In the present embodiment, the angle formed between the central axis of first tube 151 and the central axis of second tube 152 is a right angle (90°). The arrangement direction of tube 133 is the same as the arrangement direction of communication portion 145.

First tube 151 is disposed along the height direction of cartridge 130. One end of first tube 151 opens in the bottom surface of main body 131. In the present embodiment, second tube 152 is disposed such that its central axis is along the horizontal direction. Second tube 152 (tube 133) includes pressed portion 134a that controls the flow of the liquid by causing second tube 152 (tube 133) to be deformed when second tube 152 (tube 133) is pressed or released from being pressed. That is, in the present embodiment, pressed portion 134a is a part of second tube 152. Pressed portion 134a is disposed outside of main body 131. One end of second tube 152 is connected to first tube 151, and the other end opens in the side surface of protrusion 142. A portion of second tube 152 is exposed in exposure hole 143. In the present embodiment, a part of tube 133 may protrude or does not have to protrude from the bottom surface of main body 131. In the present embodiment, a portion of tube 133 slightly protrudes from the bottom surface of main body 131 to the outside. The portion protruding from the bottom surface of main body 131 functions as a leg portion of main body 131.

The material of first tube 151 is not particularly limited. The material of second tube 152 (pressed portion 134a) is not particularly limited as long as second tube 152 can exert the above-described functions. It is preferable that second tube 152 (pressed portion 134a) be formed of an elastic body. In the present embodiment, since first tube 151 and second tube 152 are integrally formed, the material of first tube 151 and the material of second tube 152 (pressed portion 134a) are the same. Examples of the material of tube 133 (first tube 151 and second tube 152 (pressed portion 134a)) include a thermoplastic elastomer and a thermosetting elastomer.

Here, a method of using the liquid handling device will be described. To begin with, as illustrated in FIG. 3, channel chip 110, interface 120, and cartridge 130 are connected to one another. Channel chip 110 and interface 120 are disposed such that inlet 115 and an opening portion of first channel member 125 face each other, and outlet 116 and another opening portion of first channel member 125 face each other. Then, channel chip 110 and interface 120 are fixed so that no gap is formed between channel chip 110 and interface 120. The fixing method for fixing channel chip 110 and interface 120 is not particularly limited, and fixation can be performed by a known method.

Interface 120 and cartridge 130 are disposed such that one opening portion of second channel member 126 and the opening portion of tube 133 face each other. Then, interface 120 and cartridge 130 are fixed so that no gap is formed between interface 120 and cartridge 130. The fixing method for fixing interface 120 and cartridge 130 is not particularly limited, and fixation can be performed by a known method. In addition, a tube connected to a negative pressure device for causing interface channel 127 to have a negative pressure, for example, is connected to the other opening portion of second channel member 126 (not illustrated).

While channel chip 110, interface 120, and cartridge 130 are being connected to one another, a part of tube 133 (pressed portion 134a) is pressed to control the flow of the liquid (liquid channel 135 is closed).

Here, interface 120 and cartridge 130 are connected to each other after channel chip 110 and interface 120 are connected to each other, but channel chip 110 and interface 120 may be connected to each other after interface 120 and cartridge 130 are connected.

Next, when the negative pressure device is operated in a state where tube 133 is released from being pressed and liquid channel 135 is opened, the liquid stored in reservoir 132 of cartridge 130 flows into channel 117 of channel chip 110 via liquid channel 135 and interface channel 127.

(Effect)

As described above, according to cartridge 130 (liquid handling device 100) of the present embodiment, tube 133 is deformed to control the flow of the liquid. It is thus possible to easily prevent the liquid inside reservoir 132 from leaking out of reservoir 132. Accordingly, the liquid can be appropriately supplied to the plurality of channel chips.

(Variation)

Next, liquid handling device 700 according to a variation of Embodiment 1 will be described. Liquid handling device 700 according to the variation of Embodiment 1 differs from liquid handling device 100 according to Embodiment 1 only in having pressing portion 134. Therefore, the same components as those of liquid handling device 100 according to Embodiment 1 are denoted by the same reference numerals, and the description thereof is omitted.

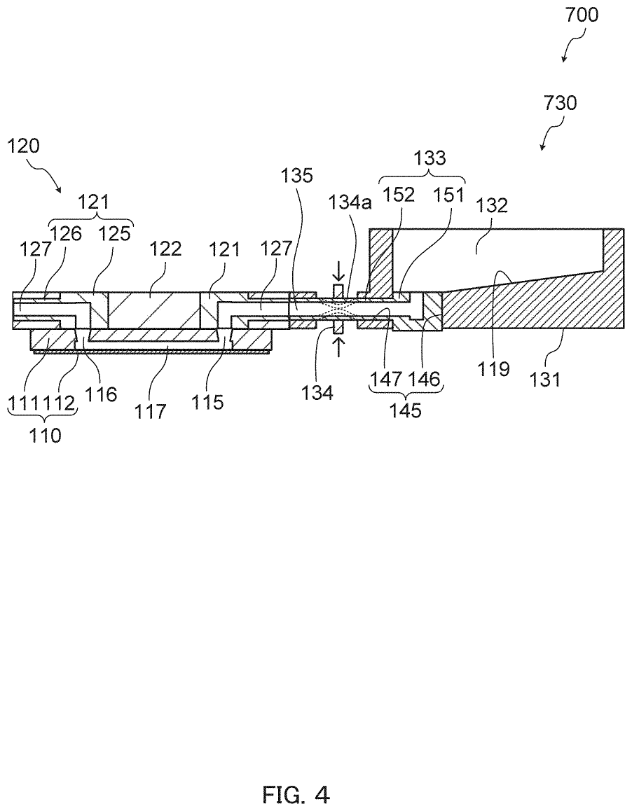

FIG. 4 is a diagram illustrating a configuration of liquid handling device 700 according to the variation of Embodiment 1.

As illustrated in FIG. 4, liquid handling device 700 includes channel chip 110, interface 120, and cartridge 730.

Cartridge 730 includes pressing portions 134 in addition to main body 131, reservoirs 132, and tubes 133.

Each of pressing portions 134 controls opening and closing of liquid channel 135 by causing tube 133 to be deformed when tube 133 is pressed or released from being pressed. That is, pressing portion 134 and tube 133 function as a pinch valve. The configuration of pressing portion 134 is not particularly limited as long as it can exert the above-described functions. For example, pressing portion 134 may be configured to pinch tube 133 in the left-right direction, or may be configured to pinch tube 133 in the up-down direction. In the present embodiment, pressing portion 134 is configured to pinch tube 133 in the up-down direction. Examples of pressing portion 134 include a cantilever, a clip, a motor-driven pressing mechanism, and a spring-type pressing mechanism.

(Effect)

As described above, liquid handling device 700 according to the variation of Embodiment 1 has the same effect as liquid handling device 100 of Embodiment 1.

### Embodiments 2 to 6

Next, liquid handling devices according to Embodiments 2 to 6 will be described. The liquid handling devices according to Embodiments 2 to 6 differ from liquid handling device 100 according to Embodiment 1 only in the configuration of the cartridge. Therefore, the same components as those of liquid handling device 100 according to Embodiment 1 are denoted by the same reference numerals, and the description thereof is omitted.

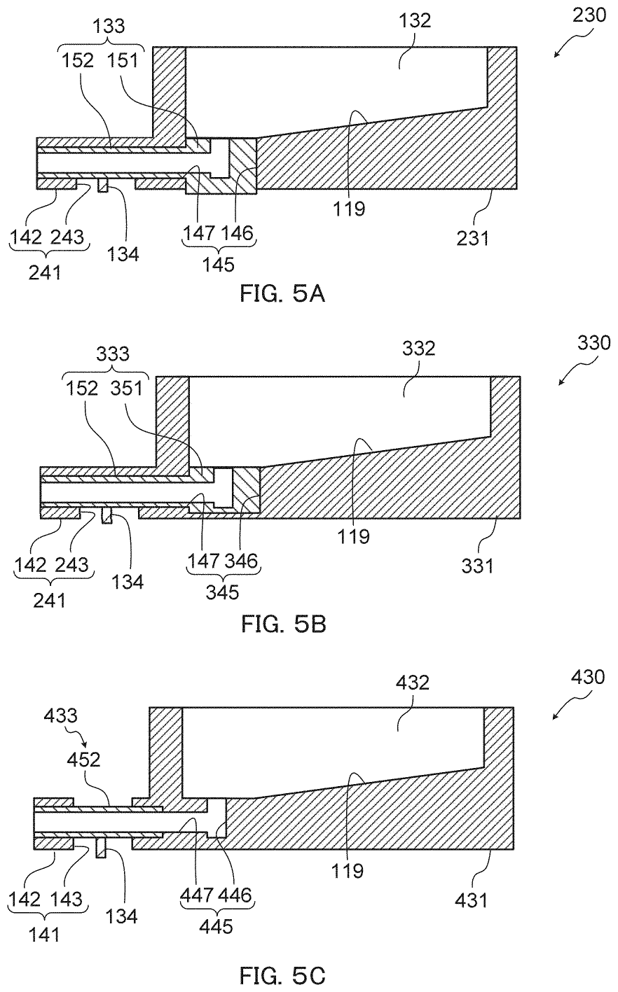

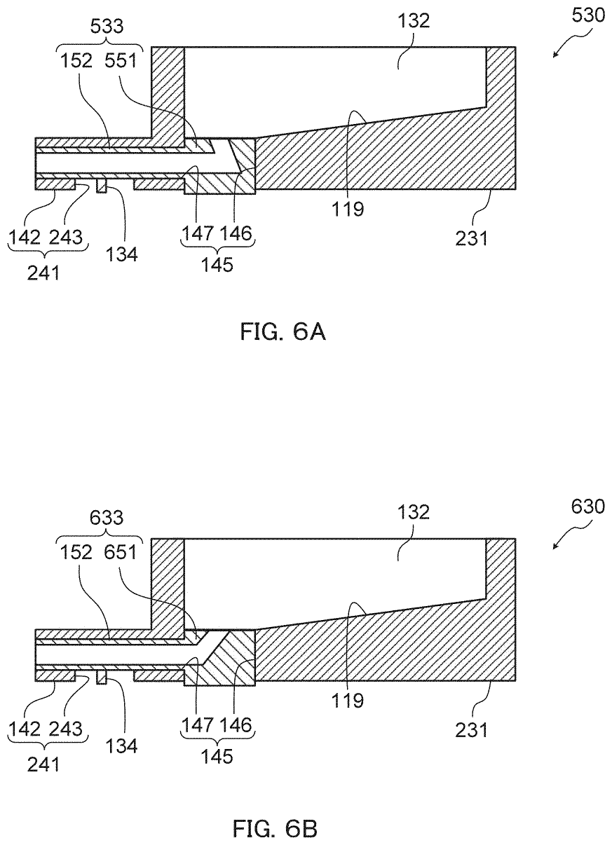

FIGS. 5A to 5C are sectional views illustrating configurations of cartridges 230, 330, and 430 according to Embodiments 2 to 4. FIG. 5A is a sectional view illustrating the configuration of cartridge 230 in Embodiment 2, FIG. 5B is a sectional view illustrating the configuration of cartridge 330 in Embodiment 3, and FIG. 5C is a sectional view illustrating the configuration of cartridge 430 in Embodiment 4. FIGS. 6A and 6B are sectional views illustrating configurations of cartridges 530 and 630 according to Embodiments 5 and 6. FIG. 6A is a sectional view illustrating a configuration of cartridge 530 according to Embodiment 5, and FIG. 6B is a sectional view illustrating a configuration of cartridge 630 according to Embodiment 6.

As illustrated in FIG. 5A, cartridge 230 according to Embodiment 2 includes cartridge main body 231, reservoirs 132, tubes 133, and pressing portions 134. Reservoirs 132, tubes 133, and pressing portions 134 are the same as reservoirs 132, tubes 133, and pressing portions 134 in cartridge 130 according to Embodiment 1, and thus descriptions thereof are omitted.

Cartridge main body 231 of cartridge 230 according to Embodiment 2 includes exposure section 241. Exposure section 241 includes protrusion 142 and exposure holes 243. Each of exposure holes 243 is a recessed portion that opens in the lower surface of protrusion 142.

As illustrated in FIG. 5B, cartridge 330 according to Embodiment 3 includes cartridge main body 331, reservoirs 332, tubes 133, and pressing portions 134. Pressing portions 134 are the same as pressing portions 134 of cartridge 130 according to Embodiment 1, and thus description thereof will be omitted.

Cartridge main body 331 of cartridge 330 according to Embodiment 3 includes exposure section 241. Exposure section 241 includes protrusion 142 and exposure holes 243. Each of exposure holes 243 is a recessed portion that opens in the lower surface of protrusion 142. In addition, communication portions 345 open in the bottom surfaces of the reservoirs 332. Each of communication portions 345 includes first communication portion 346 and second communication portion 147. First communication portion 346 does not open in the bottom surface of cartridge main body 331. That is, first communication portion 346 in the present embodiment is a recessed portion.

Tube 333 includes first tube 351 and second tube 152. First tube 351 is disposed along the up-down direction of cartridge 330. One end of first tube 351 does not open in the bottom surface of cartridge main body 331.

As illustrated in FIG. 5C, cartridge 430 according to Embodiment 4 includes cartridge main body 431, reservoirs 432, tubes 433, and pressing portions 134. Pressing portions 134 are the same as pressing portions 134 of cartridge 130 according to Embodiment 1, and thus description thereof will be omitted.

Cartridge main body 431 of cartridge 430 according to Embodiment 4 includes exposure section 141. In addition, first communication portion 446 does not open in the bottom surface of cartridge main body 431.

Communication portions 445 open in the bottom surfaces of reservoirs 432. Each of communication portions 445 includes first communication portion 446 and second communication portion 447. Tube 433 is not disposed in first communication portion 446. Thus, first communication portion 446 disposed in the bottom surface of reservoir 432 is smaller than those in the other embodiments.

Tube 433 does not include first tube 151 and includes only second tube 452. In addition, tube 433 is disposed only between the vicinity of the side wall of cartridge main body 431 and the side surface of protrusion 142.

As illustrated in FIG. 6A, cartridge 530 according to Embodiment 5 includes cartridge main body 231, reservoirs 132, and tubes 533. Cartridge main body 231 and reservoirs 132 are the same as reservoirs 132 and cartridge main body 231 of cartridge 130 according to Embodiment 1, and thus description thereof will be omitted.

In the present embodiment, each of tubes 533 includes first tube 551 and second tube 152. The angle formed between the central axis of first tube 551 and the central axis of second tube 152 is an acute angle.

As illustrated in FIG. 6B, cartridge 630 according to Embodiment 6 includes cartridge main body 231, reservoirs 132, and tubes 633. Cartridge main body 231 and reservoirs 132 are the same as reservoirs 132 and cartridge main body 231 in cartridge 130 according to Embodiment 1, and thus description thereof will be omitted.

In the present embodiment, each of tubes 633 includes first tube 651 and second tube 152. The angle formed between the central axis of first tube 651 and the central axis of second tube 152 is an obtuse angle.

(Effect)

As described above, the liquid handling devices according to Embodiments 2 to 6 have the same effect as liquid handling device 100 according to Embodiment 1.

### INDUSTRIAL APPLICABILITY

The cartridge according to the present invention is useful in various applications such as, for example, clinical test, food test, and environmental test.

### REFERENCE SIGNS LIST

100, 700 Liquid handling device
110 Channel chip
111 Substrate
112 Film
115 Inlet
116 Outlet
117 Channel
118 Side surface
119 Bottom surface
119a Horizontal surface
119b Inclined surface
120 Interface
121 First member
122 Second member
125 First channel member
126 Second channel member
127 Interface channel
128 Needle insertion portion
130, 230, 330, 430 Cartridge
131, 231, 331, 431 Cartridge main body
132, 332, 432 Reservoir
133, 333, 433 Tube
134 Pressing portion
134a Pressed portion
135 Liquid channels
141, 241 Exposure section
142 Protrusion
143, 243 Exposure hole
145, 345, 445 Communication portion
146, 346, 446 First communication portion
147, 447 Second communication portion
151, 351, 551, 651 First tube
152, 452 Second tube

1. A cartridge that is used in combination with a channel chip including a channel through which a liquid flows, the cartridge being configured to store the liquid, the cartridge comprising:
a main body;
a reservoir disposed inside the main body and configured to store the liquid; and
a tube configured such that the liquid taken in from one end of the tube communicating with the reservoir flows out from another end of the tube, wherein
the tube includes a pressed portion that controls a flow of the liquid by causing the tube to be deformed when the tube is pressed or released from being pressed, and
the pressed portion is located outside the main body.

2. The cartridge according to claim 1, wherein:
the tube includes:
a first tube that opens in a bottom surface of the reservoir, and
a second tube communicating with the channel of the channel chip, and
an angle formed between a central axis of the second tube and a central axis of the first tube is less than 180°.

3. The cartridge according to claim 2, wherein
the angle formed between the central axis of the second tube and the central axis of the first tube is 90°.

4. The cartridge according to claim 2, wherein
the second tube is disposed such that the central axis of the second tube extends along a horizontal direction.

5. The cartridge according to claim 1, wherein
the pressed portion is formed of an elastic body.

6. A liquid handling device, comprising:
a cartridge according to claim 1;
a channel chip including an inlet for introducing a liquid of the reservoir and a channel through which the liquid introduced through the inlet flows; and
an interface for connecting the cartridge and the channel chip to each other.

7. The cartridge according to claim 3, wherein
the second tube is disposed such that a central axis of the second tube extends along a horizontal direction,

8. The cartridge according to claim 2, wherein
the pressed portion is formed of an elastic body.

9. The cartridge according to claim 3, wherein
the pressed portion is formed of an elastic body.

10. The cartridge according to claim 4, wherein
the pressed portion is formed of an elastic body.

11. The cartridge according to claim 7, wherein
the pressed portion is formed of an elastic body.

12. A liquid handling device, comprising:
a cartridge according to claim 2;
a channel chip including an inlet for introducing a liquid of the reservoir and a channel through which the liquid introduced through the inlet flows; and
an interface for connecting the cartridge and the channel chip to each other.

13. A liquid handling device, comprising:
a cartridge according to claim 3;
a channel chip including an inlet for introducing a liquid of the reservoir and a channel through which the liquid introduced through the inlet flows; and
an interface for connecting the cartridge and the channel chip to each other.

14. A liquid handling device, comprising:
a cartridge according to claim 4;
a channel chip including an inlet for introducing a liquid of the reservoir and a channel through which the liquid introduced through the inlet flows; and
an interface for connecting the cartridge and the channel chip to each other.

15. A liquid handling device, comprising:
a cartridge according to claim 5;
a channel chip including an inlet for introducing a liquid of the reservoir and a channel through which the liquid introduced through the inlet flows; and
an interface for connecting the cartridge and the channel chip to each other.

16. A liquid handling device, comprising:
a cartridge according to claim 7;
a channel chip including an inlet for introducing a liquid of the reservoir and a channel through which the liquid introduced through the inlet flows; and
an interface for connecting the cartridge and the channel chip to each other.

17. A liquid handling device, comprising:
a cartridge according to claim 8;
a channel chip including an inlet for introducing a liquid of the reservoir and a channel through which the liquid introduced through the inlet flows; and
an interface for connecting the cartridge and the channel chip to each other.

18. A liquid handling device, comprising:
a cartridge according to claim 9;
a channel chip including an inlet for introducing a liquid of the reservoir and a channel through which the liquid introduced through the inlet flows; and
an interface for connecting the cartridge and the channel chip to each other.

19. A liquid handling device, comprising:
a cartridge according to claim 10;
a channel chip including an inlet for introducing a liquid of the reservoir and a channel through which the liquid introduced through the inlet flows; and
an interface for connecting the cartridge and the channel chip to each other.

20. A liquid handling device, comprising:
a cartridge according to claim 11;
a channel chip including an inlet for introducing a liquid of the reservoir and a channel through which the liquid introduced through the inlet flows; and
an interface for connecting the cartridge and the channel chip to each other.
